(19) United States
(12) Patent Application Publication
(10) Pub. No.: US 2003/0060190 A1
(43) Pub. Date: Mar. 27, 2003

(54) Method of distributing a multimedia content for use from a portable device

(76) Inventor: Raoul Mallart, Paris (FR)

Correspondence Address: U.S. Philips Corporation, 580 White Plains Road, Tarrytown, NY, 10591, US

(21) Appl. No.: 10/247,983

(22) Filed: Sep. 20, 2002

(30) Foreign Application Priority Data
Sep. 25, 2001 (FR) 0112327

(51) Int. Cl. H04M 3/42; H04M 3/00

(52) U.S. Cl. 455/414; 455/419

(57) ABSTRACT

The invention proposes a method of distributing multimedia content (film, games, tourist information) for use on a portable device. The method according to the invention consists of downloading a content to be used from a server (3) to a base station (2), storing the content in a storage memory of the base station, and transmitting the content of the base station to a portable device for using multimedia content (1) for utilization as the transmission progresses. Application: video display in a vehicle on a portable screen.

### FIELD OF THE INVENTION

The present invention relates to a wireless communication system comprising at least one server and at least one mobile terminal, for downloading data from said server to said mobile terminal, said mobile terminal comprising a storage memory for storing downloaded data.

The invention also relates to a server, a base station and a portable device for using the multimedia content able to be used in such a wireless communication system.

The invention also relates to a method of distributing a multimedia content.

### BACKGROUND OF THE INVENTION

European patent application No. 1 022 656 filed on Dec. 15, 1999 describes a radio communication system which comprises a server for downloading programs, such as navigation programs or games, to terminals installed in vehicles.

The invention relates in particular to the downloading of a multimedia content, for example a video, from a server to a terminal, for use of said multimedia content, for example in a vehicle.

### SUMMARY OF THE INVENTION

A wireless communication system according to the invention as described in the introductory paragraph is characterized in that, said data constituting a multimedia content, said mobile terminal comprises a base station and a portable device for using multimedia content, said storage memory being contained in said base station, said server and said base station comprising a wireless downloading module having a sufficient transmission rate for rapidly downloading a multimedia content from said server to said base station when said base station is in a coverage area of said server, and said base station and said portable device comprising a wireless transmission module having a sufficient transmission rate for transmitting to said portable device a multimedia content stored in said storage memory, for use of said multimedia content along with said transmission.

The invention, which consists of downloading the multimedia content from a server, makes it possible to dispense with the physical medium (disk or cassette). It makes it possible to access a wide choice of contents without having to hold the corresponding physical media. This is particularly advantageous when the user is moving about. The invention also makes it possible to adapt the multimedia contents offered to the location of the user, for example to offer him tourist information relating to the geographical area in which he is situated.

The mobile radio communication networks existing at present are too slow and too expensive to be used for transmitting large quantities of data, continuously, from a server to a portable device over a significant length of time. It is in particular impossible to transmit a video continuously throughout the duration of display of the video from a server to a mobile terminal for a video-on-demand application. By way of example, the GPRS standard makes it possible to transmit 50 kbps (kilo bits per second) when the network is not excessively loaded. With the UMTS standard, it is possible to achieve transmission rates of 384 kbps, but this rate is to be shared between all the users of the same cell. However, at the present time, in order to transmit a video of satisfactory quality continuously, it is necessary to have a transmission rate available of at least 600 kbps.

The invention, which consists of downloading the multimedia content to the mobile terminal via a very high-rate wireless link when the base station is situated in the coverage area of the server, and storing the multimedia content locally prior to any use, makes it possible to be free of these limitations.

In addition, it is desirable for the multimedia content utilization device to be a portable device in order to improve the ease and flexibility of use for the user. In particular, when the portable device is a portable display device, the user can position it at his convenience in order to optimize his ease of viewing. In addition, by using a portable device according to the invention, the user can access the multimedia content of his choice whenever he is close to a base station. Such a portable device can for example be used with a fixed base station placed in the house when the user is at home, with a mobile base station placed in a car, in a train, or in an aircraft when he is moving.

The invention, which consists of storing the multimedia content in the base station and transmitting the multimedia content to the portable device as it is used, makes it possible to avoid storing the multimedia content in the portable device. This is very advantageous since the storage of a multimedia content requires a large memory, and such memories are expensive, bulky and consume a great deal of power, which means that the portable device will run for less time before requiring recharging.

Advantageously, said portable device comprises a user interface for selecting a multimedia content to be downloaded, and for paying for said multimedia content to be downloaded.

The base station is for example placed in a vehicle (car, bus, train, aircraft), and the server is for example placed in a service and/or parking area (for example in a service station, in a car park etc).

### BRIEF DESCRIPTION OF THE DRAWINGS

The invention will be further described with reference to examples of embodiment shown in the drawings to which, however, the invention is not restricted:

FIG. 1 is a diagram of a first embodiment of a wireless communication system according to the invention,

FIG. 2 is a diagram of a second embodiment of a wireless communication system according to the invention,

FIG. 3 is a diagram describing the steps of a first embodiment of a method according to the invention for distributing multimedia content,

FIG. 4 is a diagram describing the steps of a second embodiment of a method according to the invention for distributing multimedia content,

FIG. 5 is a diagram of a fourth embodiment of a wireless communication system according to the invention.

### DESCRIPTION OF PREFERRED EMBODIMENTS

In the remainder of the description, the case is adopted where the multimedia content to be distributed is a video, since video-on-demand distribution constitutes a particularly advantageous application of the invention. This is not restrictive. The invention is applicable in general terms to any type of multimedia content (audio, fixed images, etc).

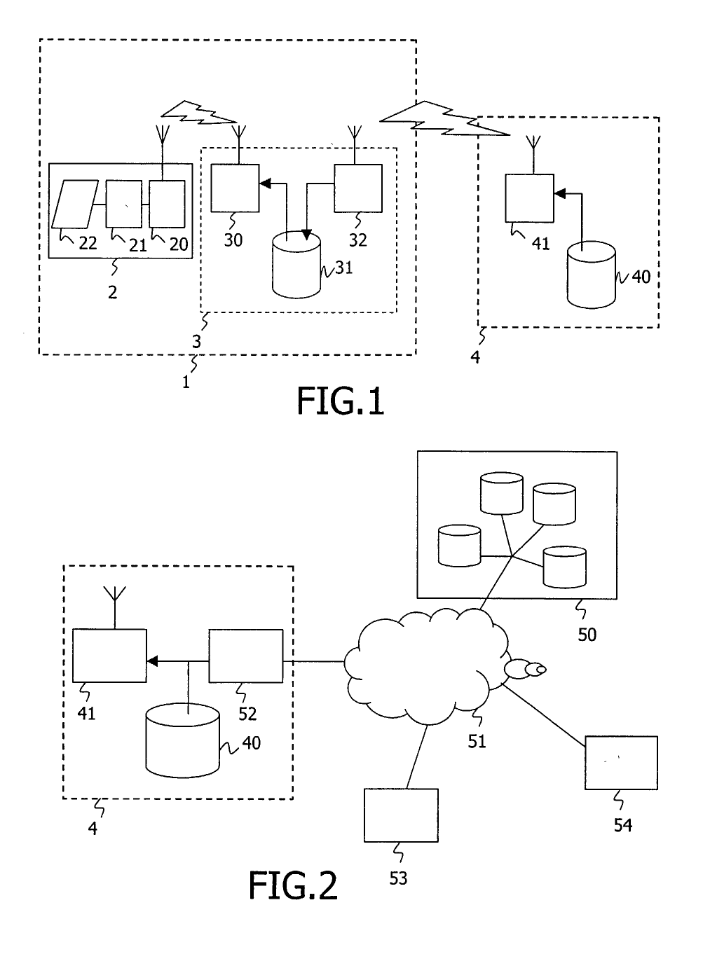

FIG. 1 depicts a block diagram of a first embodiment of a wireless communication system according to the invention. According to FIG. 1, a wireless communication system according to the invention comprises a mobile terminal 1 consisting of a portable video display device 2 and a base station 3. It also comprises a server 4. The portable device 2 comprises a wireless transmission module 20, a video processing module 21 and a display screen 22. The base station 3 comprises a wireless transmission module 30 of the same type as the wireless transmission module 20, a video storage memory 31 and a wireless downloading module 32. The server 4 comprises a database 40 and a wireless downloading module 41 of the same type as the wireless downloading module 42. The screen 22 is designed to offer the user a man/machine interface (not shown in the figure) to enable him to select and pay for a film to be downloaded. The database 40 is for example stored on an integrated circuit or a hard disk. The wireless transmission modules 20 and 30 are for example based on the wireless communication standard known as “Bluetooth” (the Bluetooth standard relates to a short-range radio link at 2.4 GHz having a transmission rate of 1 Mbps). Any other wireless communication standard having a rate from between 600 kbps and 1 Mbps can also be used. The downloading modules 22 and 31 are for example based on IEEE 802.11b (IEEE 802.11b is a wireless transmission standard for local area networks having a rate of 11 Mbps). Any other wireless communication standard having a rate greater than several megabits per second can also be used.

The server 4 is advantageously located in a service area, for example in a service station, in a commercial parking area, in a tourist parking area, in a motorway rest area etc. The server 4 is then managed by a service provider.

FIG. 2 shows a second embodiment of a system according the invention. According to FIG. 2, the server 4 is a relay with local storage to a remote server 50 via the Internet 51. The server 4 comprises a module 52 for connection to the Internet. The content of the database 40 of the server 4 is managed by a remote manager 53 also connected to the Internet 51. The remote manager 53 decides on eliminations and additions to be made to the catalogue. He keeps the catalogue up to date and modifies the prices. He initiates the downloading of content from the remote server 50 to the server 4. In order to make payment, a secure transaction is established between the portable device 2 and a transaction server 54 also connected to the Internet 51.

In a third embodiment, not shown, access between the server 4 and the remote server 50 is sufficiently rapid for there to be no need to store the multimedia contents at the server 4.

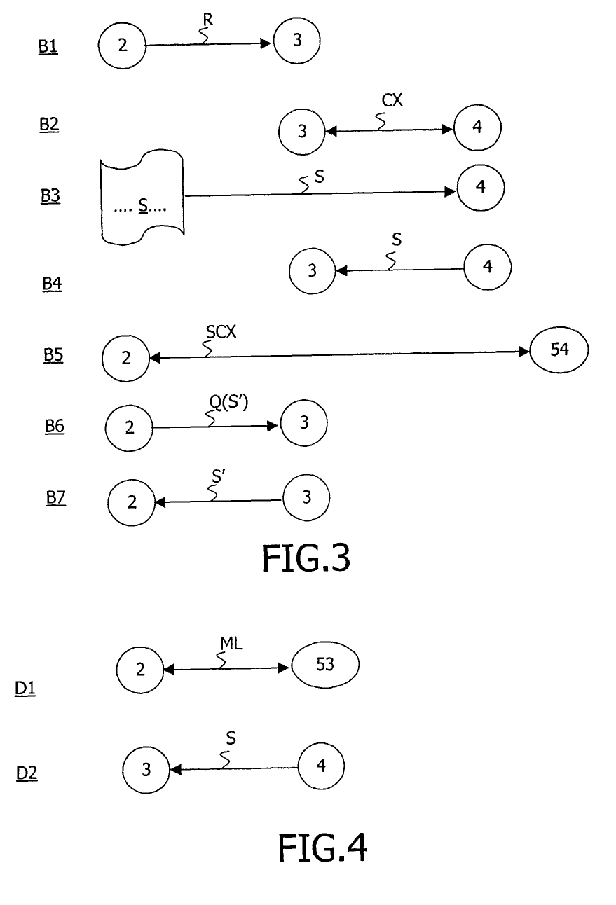

FIG. 3 depicts the various steps of a first embodiment of a method according to the invention for distributing multimedia content. At step B1, a user makes a request R for access to a multimedia content distribution service. This request R is transmitted to the base station 3, which initiates a connection CX with the server 3. The connection between the base station 3 and the server 4 is established at step B2, if the base station 3 is in the area of coverage of the server 4. At step B3, the user accesses a multimedia content catalogue using a transfer protocol of the HTTP (Hypertext Transfer Protocol) type and a document description language of the HTML (Hypertext Markup Language) or XML (Extensible Markup Language) type, and selects a content S. The catalogue contains for example films, games, tourist information etc. At step B4, the content selected S is downloaded from the server 4 to the base station 3, for example using a file transfer protocol of the FTP (File Transfer Protocol) type. By way of example, such a downloading lasts for approximately 8 minutes for a file of 650 Mbytes on an IEEE 802.11b connection. The downloaded file is stored in the storage memory 51. At step B5, a secure connection SCX is established between the portable device 2 and the transaction server 54 in order to pay for the downloaded content S, for one or more displays. At step B6, the user makes a request Q to display a content S′ stored in the storage memory 31. At step B7, the content S′ is transmitted and displayed on the screen 22 at the same time as the transmission. HTTP, HTML and XML are standards defined by the W3C consortium. FTP is a standard defined by the IETF.

FIG. 4 depicts a second embodiment of a method according to the invention for distributing multimedia content. In this second embodiment, the choice of the content and the payment are made in advance, at step D1, before entering the area of coverage of the server 4, for example via a mobile link MC of the WAP type (Wireless Access Protocol; WAP is a lightened Internet version for mobile applications) established between the base station 3 and the remote manager 53. The downloading commences when the base station 3 enters the area of coverage of the server 4 (step D2).

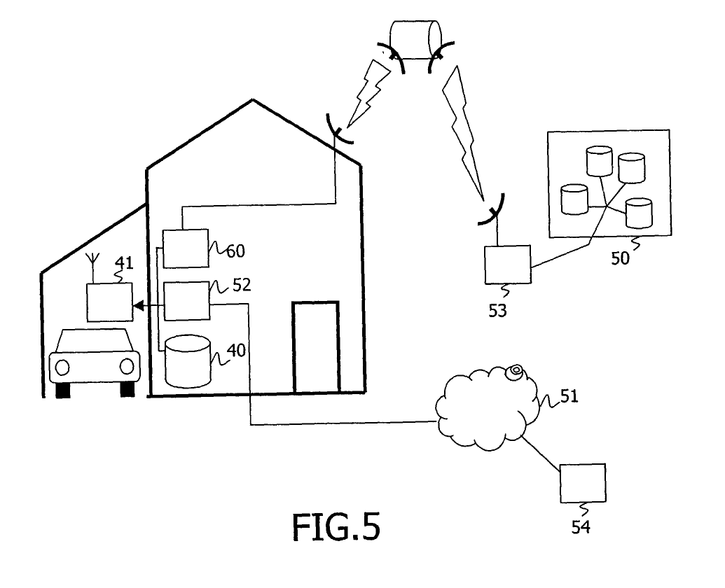

FIG. 5 depicts a fourth embodiment of a distribution system according to the invention. In this embodiment, the server 4 is located in the garage of the owner of the car. The server 4 comprises, in addition to the wireless transmission module 41 and the module 52 for connection to the Internet, a satellite reception module 60. The database 40 of the server 4 is managed by a remote manager 53 via a satellite link. The remote manager 53 is connected to a remote server 50. To make payment, a secure transaction is established between the portable device 2 and a transaction server 54, which is also connected to the Internet 51. This fourth embodiment enables the user for example to load multimedia contents into the base station with which his car is equipped before going on a journey.

1. A wireless communication system comprising at least one server (4) and a mobile terminal (1) for downloading data from said server to said mobile terminal, said mobile terminal comprising a storage memory (31) for storing downloaded data, characterized in that said data constitute a multimedia content,
said mobile terminal comprises a base station (3) and a portable device for using a multimedia content (2), said storage memory being contained in said base station,
said server and said base station comprise a wireless downloading module (32; 41) having a transmission rate sufficient to rapidly download a multimedia content from said server to said base station when said base station is in an area of coverage of said server,
and said base station and said portable device comprise a wireless transmission module (20; 30) having a transmission rate sufficient to transmit to said portable device a multimedia content stored in said storage memory, for use of said multimedia content as said transmission progresses.

2. A wireless communication system as claimed in claim 1, characterized in that said portable device comprises a user interface for selecting a multimedia content to be downloaded.

3. A base station (3) containing a wireless downloading module (32) for downloading a multimedia content from a server (4) when said base station is situated in an area of coverage of said server, a storage memory (31) for the downloaded multimedia content, and a wireless transmission module (30) for transmitting a multimedia content stored in said storage memory to a portable device for using the multimedia content (2), for use of said multimedia content as the transmission progresses.

4. A vehicle comprising a base station as claimed in claim 3.

5. A portable device for using a multimedia content (2) comprising a wireless transmission module (20) for receiving a multimedia content coming from a base station (3) provided with a storage memory (31) for said multimedia content, for use of said multimedia content as it is received.

6. A portable device as claimed in claim 5, characterized in that it comprises a user interface for selecting a multimedia content to be downloaded from a server to said base station.

7. A method of distributing a multimedia content, characterized in that it comprises a step (B4) of downloading by wireless link said multimedia content from a server (4) to a base station (3), with a view to the storage of said multimedia content in a storage memory (31) of said base station, for subsequent wireless transmission of said multimedia content to a portable device for using multimedia content (2), and use of said multimedia content as said transmission progresses.

8. A method of distributing a multimedia content as claimed in claim 7, characterized in that it comprises a step (B3) of selecting the multimedia content to be downloaded via a user interface of said portable device.

9. A method of distributing a multimedia content as claimed in claim 8, characterized in that it comprises a step (B5) of paying for the multimedia content selected with a view to one or more displays.

10. A method of distributing multimedia content as claimed in claim 7, characterized in that said base station is placed in a vehicle and said server is placed in a service and/or parking area.

11. A server (4) intended to be used in a wireless communication system as claimed in claim 1.
